(19) United States
(12) Patent Application Publication
(10) Pub. No.: US 2008/0138673 A1
(43) Pub. Date: Jun. 12, 2008

(54) Fuel Cell Stacks and Methods for Controlling Fuel Gas Flow to Different Sections of Fuel Cell Stacks

(76) Inventors: Jesper Bech-Madsen, Svendborg (DK); Torsten Brandt, Svendborg (DK); Jorgen S. Lundsgaard, Svendborg (DK)

Correspondence Address: LICATA & TYRRELL P.C., 66 E. MAIN STREET, MARLTON, NJ, 08053, US

(21) Appl. No.: 11/813,734

(22) PCT Filed: Jan. 13, 2006
(86) PCT No.: PCT/IB06/00057

§ 371 Date: Nov. 6, 2007

Related U.S. Application Data
(60) Provisional application No. 60/644,856, filed on Jan. 18, 2005.

(51) Int. Cl. H01M 8/02; H01M 8/24

(52) U.S. Cl. 429/13; 429/34

(57) ABSTRACT

Fuel cell stacks with baffle plates inserted between the individual fuel cells or series of individual fuel cells which change the directional flow of fuel in the fuel cells thereby enhancing their performance with reformer gas are provided.

This patent application claims the benefit of priority from U.S. Provisional Application Ser. No. 60/644,856, filed Jan. 18, 2005, teachings of which are herein incorporated by reference in their entirety.

### BACKGROUND OF THE INVENTION

A conventional hydrogen Polymer Electrolyte Membrane (PEM) fuel cell configuration is depicted herein in FIG. 1. In this conventional configuration, the required number of single cells is stacked and the gas supply to each single cell is connected in parallel. Fuel and air required for the electrochemical reaction are fed at the appropriate rate via common manifolds. The direction of the gas flow is arbitrary and is shown as falling arrows in FIG. 1. Fuel gas supply to each of the individual cells from the manifold at the top of the stack is essentially equal. Similarly, the exhaust gas is collected and removed from the stack via the outlet manifold at the bottom of the stack. Thus, in the conventional fuel cell configuration shown in FIG. 1, the supply gas flow follows in parallel flow paths in identical flow directions and at uniform flow rates through each of the individual cells.

Hydrogen fuel gas flow is adjusted to correspond to an anode stoichiometry of λ=1.1. That is, preferably 20% excess of the stoichiometric hydrogen consumption will be supplied in order for the fuel cell to operate satisfactorily. The exhaust hydrogen flow ensures complete purging of the cell. A greater excess of gas affects the psychometric balance and may lead to undesirable hydration of the PEM causing cell malfunction.

In certain situations, particularly where hydrogen produced by electrolysis is not feasible or not available in sufficient quantity or reasonable cost, it is of interest to supply fuel cells with degraded hydrogen supplies such as that provided by reforming processes wherein carbon reacts with steam at elevated temperatures to produce a mixture of CO and H₂ or cracked ammonia. It is thus desirable to obtain reformer fuels or gases for electrochemical fuel cells via catalytic reforming of hydrogen-rich fuels from the copious supply of carbon available as organic refuse or other sources such as low grade petroleum deposits including, but not limited to oil-shale, oil sand, gilsonite and coal. Both fossil fuels, such as natural gas, petrol or heating oil and biogenic/regenerative fuels, such as wood, alcohol or rapeseed oil, can be used in this process. Methods are known for producing a CO—H₂ mixture from organic material. Such methods are adaptable to, for example, carbon deposits from petroleum coke or from coal deposits for conversion into a CO—H₂ mixture. This mixture can then be burnt in conventional furnaces or used as a reformer gas source of hydrogen for direct electrochemical conversion in fuel cells. In cases where 100% of the hydrogen gas supply is replaced by reformer gas containing 75% hydrogen and 25% of either nitrogen or carbon dioxide, it has been observed that individual cells in the stacked sequence fail unpredictably after a certain time. It is not possible to predict the operational time period before cell performance deteriorates, nor is it possible to predict which cell and how many cells will fail. It is possible to revive the affected cells in a stack by either switching to pure hydrogen gas supply for a short time period, or by increasing the gas flow rate by a factor of 2.5-3 (depending on the number of cells in the stack) for a limited period of time.

While single cells perform well and predictably under these conditions, when stacked one or more cells can become locally depleted of fuel gas on the anode side. As a consequence, these cells suddenly operate at a fuel stoichiometry of λ<1 thus resulting in cell voltage decreases and, in some cases, a reversal of the electrochemical process occurring in the cell. Such an event can lead to permanent damage of the fuel cell stack.

The problem appears to be related to uneven fuel supply on the anode side to certain cells in the fuel cell stack. An anode stoichiometry λ close to 2.8 is required to ensure that a stack of 70 cells operates. A lesser λ value in the range of 1.5 to 2 will suffice for a smaller stack of 25 cells.

U.S. Pat. No. 6,187,464 discloses a method for activating fuel cells to overcome problems in their performance relating to carbon monoxide in the fuel gas poisoning the platinum catalyst and to the water-repelling property of polymer electrolyte membrane. In this method, at least one unit cell is configured to include a proton conductive polymer electrolyte, an electrode layer having a catalytic activity arranged on both faces of the polymer electrolyte membrane and a gas-supplying path so that the catalytic activity of the electrode is enhanced and/or to provide a wetting condition to the polymer electrolyte.

### SUMMARY OF THE INVENTION

The present invention relates to a fuel cell stack design providing for careful control of the fuel gas flow to different sections of the fuel cell stack, thereby eliminating problems associated with uneven fuel supply on the anode side to certain cells in the fuel cell stack.

One aspect of the present invention relates to a fuel cell stack comprising a baffle plate placed between a first individual fuel cell or a first series of fuel cells in the fuel cell stack and a second individual fuel cell or a second series of fuel cells adjacent to the first individual fuel cell or the first series of fuel cells in the fuel cell stack, said baffle plate changing directional flow of fuel between the first individual fuel cell or first series of fuel cells and the second individual fuel cell or second series of individual fuel cells.

Another aspect of the present invention relates to a method for altering directional flow of fuel in a fuel cell stack which comprises placing a baffle plate between a first individual fuel cell or a first series of individual fuel cells in the fuel cell stack and a second individual fuel cell or a second series of fuel cells adjacent to the first individual fuel cell or the first series of fuel cells in the fuel cell stack, said baffle changing directional flow of fuel between the first individual fuel cell or first series of fuel cells and the second individual fuel cell or second series of individual fuel cells.

### BRIEF DESCRIPTION OF THE FIGURES

FIG. 1 is a diagram depicting a conventional fuel cell stack gas flow configuration.

FIG. 2 is a diagram of an embodiment of the present invention wherein the fuel cell stack contains individual cells grouped into sections and divided by baffle plates which change the directional flow of the fuel.

FIG. 3 is a diagram of an embodiment of a fuel cell stack of the present invention with 70 single cells stacked adjacently, with the directional flow of gas being altered by insertion of a baffle plate after the first series of 30 cells, after the next series of 20 cells and after the next series of 12 cells.

FIG. 4 shows is a line graph showing the voltage as a function of λ for a conventional fuel cell stack such as depicted in FIG. 1 containing 25 cells with a parallel connected gas flow.

FIG. 5 is a line graph showing the voltage as a function of λ for a fuel cell stack designed in accordance with the present invention with baffle plates which change the directional flow of the fuel.

### DETAILED DESCRIPTION OF THE INVENTION

The present invention provides fuel cell stacks and methods for use thereof which provide for careful control of the fuel gas flow in different sections of the fuel cell stack.

In simplest form, a fuel cell stack of the present invention comprises a first individual fuel cell or a first series of fuel cells in a fuel cell stack, a second individual fuel cell or a second series of fuel cells adjacent to the first individual fuel cell or the first series of fuel cells in the fuel cell stack, and a baffle plate positioned in between the first individual fuel cell or first series of fuel cells and the second individual fuel cell or second series of fuel cells which changes directional flow of fuel between the first individual fuel cell or first series of fuel cells and the second individual fuel cell or second series of individual fuel cells.

In general, a stack of fuels cells will comprise more than one baffle plate inserted at selected places in the stack. These baffle plates thus serve to organize the flow into sections of cells, each section comprising a selected number of cells. The sections are connected in series so that gas flow cascades from one section to the next. The baffle plates necessarily affect the bulk flow of fuel in each section and the fuel gas flows at selected flow rates in each section. Thus, the baffle plates serve to divide the gas flow so the stoichiometric ratio in each section may be set at an arbitrary value. Since fuel is denuded as the gas flows downstream from one section to the next, the number of cells in the subsequent section is preferably decreased, consequently raising the stoichiometric ratio λ in that section. The baffle plates restrict and direct gas flow through each section of the entire stack and stabilize the gas flow at a desired flow rate through each single cell in each section.

Accordingly, the general principle behind the present invention is to section the stack so as to ensure and maintain a locally high value of an effective stoichiometry. The exact division of the stack in sections can be computed and is dependant on the actual stack size and electrical requirements. For example, provided the total number of cells (n), and the required stoichiometry of each cell λ* are known, the number of cells in each section may be calculated as follows:

$$n = {\sum }_{i = 1}^{j} {n}_{i}$$

wherein the stack is divided into i=1, 2, 3 . . . , j sections, and the number of cells in section i is nᵢ.

The main aim is to ensure that the stoichiometry (λᵢ) of section number i, is equal to the required (or effective) stoichiometry λ*, and that λ*>λ. The value of λ* is calculated according to:

$${λ}^{*} = \frac{λ \cdot n - ( {\sum }_{k = 0}^{i - 1} {n}_{k} - {n}_{o} )}{{n}_{i}}$$

which is valid for λ>1.

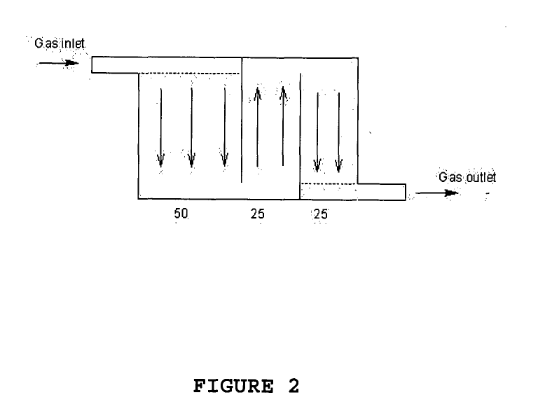

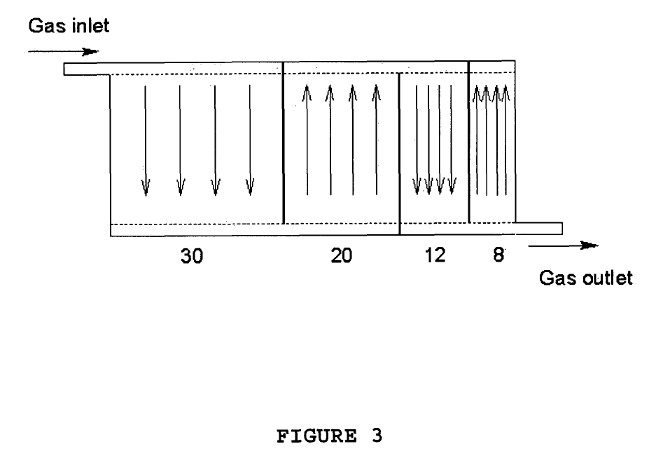

Exemplary embodiments of the present invention are depicted in FIGS. 2 and 3.

In the embodiment depicted in FIG. 2, the baffle plates 2 divide the stack of fuel cells 3 arbitrarily in three sections of 50, 25 and 25 cells each. The supply of gas is now first distributed between only 50 cells, rather than 100, and consequently, the gas flow through each individual cell in the first section is doubled. Similarly, in section two and three, which only have 25 cells each, the gas flow in the section is further doubled to 4 liters/minute. Thus a significant increase in gas flow through individual cells is achieved. Furthermore, while the gas is gradually depleted for the active component (hydrogen) on its way through the stack, the fuel cell stack design of the present invention ensures that the depletion is compensated by a stepwise increase in the flow rate and in the corresponding stoichiometric excess as expressed by the λ-value.

Another embodiment of the present invention is depicted in FIG. 3. FIG. 3 shows a stack of 70 cells divided in four sections having 30, 20, 12 and 8 single cells, respectively.

For effective operation of a fuel cell stack, the rate of the gas flow of the fuel gas is adjusted to correspond to an overall stoichiometry of λ=1.2. That is, a 20% stoichiometric excess of fuel gas is applied to the stack as is commonly the case in a conventional stack design.

The exact amount of hydrogen needed in the fuel cell stack to provide this stoichiometric excess can be determined as follows:

Q_{H} is defined as units of hydrogen which corresponds to the exact stoichiometric amount of hydrogen needed for the production of the required current in any single cell, i.e. λ=1.0. For the desired excess value of λ=1.2 (λe), the following formula is used to calculate Q_{H}.

λe*λ*number of cells in stack=Q_{H}

### Thus, for a stack of 70 cells wherein λe is 1.2 and λ is 1, the units of hydrogen or Q_{H} are 84.

For a fuel cell stack designed in accordance with the present invention, such as that exemplified in FIG. 3, wherein the first section of the stack contains 30 single cells, each consuming one unit Q_{H} of hydrogen, after passage of the fuel through first section, the number of hydrogen units is reduced to 54 Q_{H} units. The effective anode stoichiometry of the first section, λ₁ is 84/30 or 2.8.

The effective stoichiometries of the following sections of the fuel cell stack of the present invention designed in accordance with the exemplary embodiment depicted in FIG. 3 can be calculated in a similar manner. The resulting calculated stoichiometries are summarized in Table 1.

TABLE 1

| | Q_{H} units | Q_{H} units | |
|---|---|---|---|
| # cells | used | remaining | λ_{effective} |
| 30 | 30 | 54 | 2.8 |
| 20 | 20 | 34 | 2.7 |
| 12 | 12 | 22 | 2.8 |
| 8 | 8 | 14 | 2.8 |

As shown in Table 1, dividing the fuel cell stack into sections with baffle plates and directing the fuel gas sequentially through the several sections, the nominal stoichiometry is increased from λ=1.2, to an effective value of approximately 2.8 in each of the several sections of the stack.

This increase in nominal stoichiometry of the fuel cell stack design of the present invention was shown to provide for a more effective fuel cell stack with reformer gases.

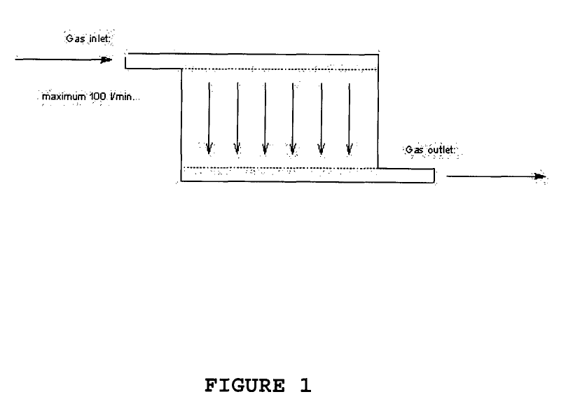

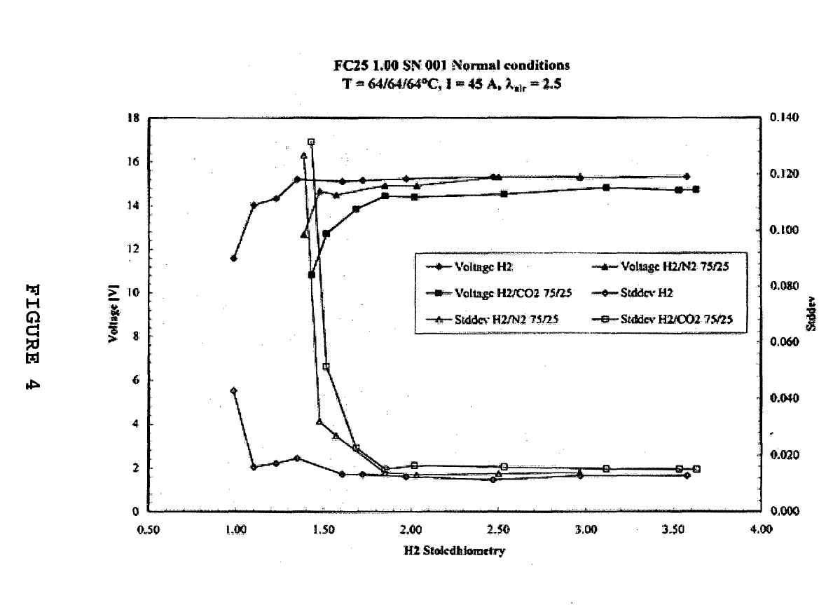

FIG. 4 shows results from experiments measuring the voltage as a function of λ for a conventional fuel cell stack containing 25 cells with a parallel connected gas flow. The stack was constructed similarly to the stack depicted in FIG. 1. At values of λ above 1.50 the cell operated flawlessly, and there were no indications of malfunction. However, while the operation continued unaffected down to λ approximately equal to 1.1-1.2 when pure hydrogen was used as the fuel gas, the voltage decreased dramatically below λ=1.50 when reformer gas was used.

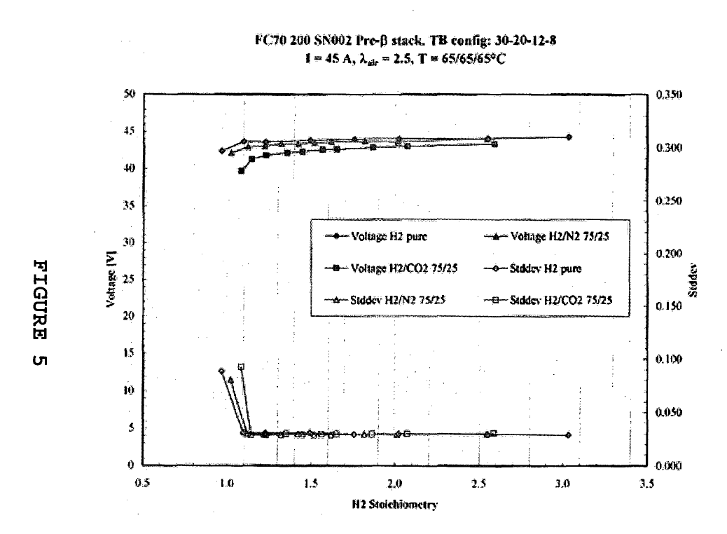

In contrast, with a fuel cell stack designed in accordance with the present invention virtually no deviation was observed when the stack was fed with reformer gas containing nitrogen and only a small deviation was observed when carbon dioxide was used, compared to using pure hydrogen fuel gas (see FIG. 5).

As will be understood by those skilled in the art upon reading this disclosure, while the present invention has been illustrated by the exemplary embodiments depicted in FIGS. 2 and 3, it is foreseen that other designs based on this method are possible.

What is claimed is:

1. A fuel cell stack comprising:
(a) a first individual fuel cell or a first series of fuel cells;
(b) a second individual fuel cell or a second series of fuel cells adjacent to the first individual fuel cell; and
(c) a baffle plate placed between said first individual fuel cell or first series of fuel cells and said second individual fuel cell or second series of fuel cells, said baffle plate changing directional flow of fuel between said first individual fuel cell or first series of fuel cells and said second individual fuel cell or second series of individual fuel cells.

2. A method for altering directional flow of fuel in a fuel cell stack comprising placing a baffle plate between a first individual fuel cell or a first series of individual fuel cells in the fuel cell stack and a second individual fuel cell or a second series of fuel cells adjacent to the first individual fuel cell or the first series of fuel cells in the fuel cell stack, said baffle changing directional flow of fuel between the first individual fuel cell or first series of fuel cells and the second individual fuel cell or second series of individual fuel cells.
